(19) United States
(12) Patent Application Publication
(10) Pub. No.: US 2002/0097505 A1
(43) Pub. Date: Jul. 25, 2002

(54) Single-element catadioptric condenser lens

(76) Inventor: James A. DeLong, Shady Shores, TX (US)

Correspondence Address: TEXAS INSTRUMENTS INCORPORATED, P O BOX 655474, M/S 3999, DALLAS, TX, 75265

(21) Appl. No.: 09/998,261

(22) Filed: Nov. 30, 2001

Related U.S. Application Data
(60) Provisional application No. 60/250,417, filed on Nov. 30, 2000.

(51) Int. Cl. G02B 17/00

(52) U.S. Cl. 359/726; 359/727

(57) ABSTRACT

A low f-number, single-element, catadioptric condenser lens (30) with four optical surfaces (21-24), which is capable of collecting light at large angles and large pupil diameters. Two of the four surfaces (22, 23) are reflective surfaces immersed in the lens refractive material (25), while the other two surfaces (21, 24) are refractive surfaces and fabricated on the surface of the lens. Two embodiments of the lens are disclosed; a low-obscuration type and a wide-field type. This condenser lens provides improved light collection efficiency overall and has lower obscuration in the center portion of the reformed light source (26), as well as improved optical aberration and stray light properties. The integration of the optical surfaces into a single package results in a more reliable and lower cost condenser lens.

### BACKGROUND OF THE INVENTION

1. Field of the Invention

The present invention relates to the field of optics and particularly to the area of condenser lenses.

2. Description of the Related Art

It is difficult to collect collimated light emitted at wide beam angles from a large aperture source without using several powerful lens elements. Often the primary collimating optics (e.g., parabolic reflector) cannot efficiently collect the source light and project it uniformly to the collimator output without introducing significant optical aberrations. Several lens elements typically are required to focus the light from the collimating optics in such a way as to maximize the system luminance. This can increase both the size and cost of the system optics.

FIG. 1 is a block diagram for a typical light collection system used in a digital micromirror device (micromirror) video projector. The system consists of: a light source 11, in this case a xenon arc lamp; an elliptical mirror 12; primary condenser optics 10, consisting of a truncated conical mirror 13 and a conical folding mirror 14; a secondary condenser pair 16; a micromirror 18; and a projection lens 19. A reformed light source 15 (spot of light) at the output of the light collection optics contains as much of the source emitted light as possible. The secondary condenser pair 16 tailors the light beam into an illumination cone 17, which is as close as possible to the size of the micromirror 18, in order to gain the maximum utilization of the available light. Typically, the illumination cone 17 is circular as compared to the micromirror's rectangular shape, which results in an inefficient use of the light. Rectangular light integration rods can also be used to more closely match the light beam to the surface of the micromirror.

Of special interest to this invention is the primary condenser optics 10 used to collect as much of the available light from the source as possible. As mentioned above, this consists of a truncated conical mirror 13 and a conical folding mirror 14. As shown, light from the source 11 is reflected by the elliptical mirror 12 and then double folded by means of the primary condenser optics 10, resulting in the reformed light source 15. The light is first folded by the truncated conical mirror 13 back on to the conical folding mirror 14, which then focuses the light into the reformed spot 15. This approach also helps to fill in the center portion of the light spot where the lamp lead does not emit light. However, this type of light collection system is often inefficient, introduces significant optical aberrations, tends to be bulky, and is costly.

There is a need for a single condenser element to replace the rather bulky and costly primary condenser optics 10, discussed above. The invention disclosed herein addresses this need.

### SUMMARY OF THE INVENTION

This invention discloses a low f-number (high numerical aperture), single-element, catadioptric condenser lens that addresses the shortcomings of conventional condenser optics. The disclosed catadioptric condenser is a single lens element with four optical surfaces that is capable of collecting light at large angles and large pupil diameters. Two of the four surfaces are reflective surfaces, which are immersed in the lens refractive material and the other two are refractive surfaces fabricated on the surface of the refractive material.

The invention relates to the combining of the four optical surfaces in a single catadioptric lens element. Two embodiments of the invention are disclosed: (1) a low-obscuration condenser and (2) a wide-field condenser. The low-obscuration embodiment consists of convex refractive—concave reflective—convex reflective—convex/concave refractive sequential elements from input to output of the lens. In this embodiment, the positive power of the large convex refractive surface bends the light in such a way as to reduce the ray height at the concave secondary reflector, allowing reduced central obscuration and more light to be transmitted. The wide-field embodiment consists of concave refractive—concave reflective—convex refractive—convex/concave refractive sequential elements from input to output of the lens. In this embodiment, the negative power of the large concave refractive surface bends the rays of light in such a way as to reduce the ray incidence angles at the concave primary reflector, allowing the primary surface to be spherical and thereby providing compensation for the collimator optical aberrations.

This single element catadioptric condenser lens potentially provides some of the following advantages:

1. efficient source light collection,

2. fewer lens elements,

3. common shapes (radii) for the reflective and refractive surfaces,

4. lower fabrication and assembly cost,

5. efficient stray light rejection, and

6. reduced central obscuration.

### DESCRIPTION OF THE VIEWS OF THE DRAWINGS

The included drawings are as follows:

FIG. 1 is a block diagram of a typical light collection system used in a micromirror video projector. (prior art)

FIG. 2 is a drawing of the single element, low obscuration, catadioptric condenser lens of the first embodiment of this invention.

FIG. 3a is a sketch identifying the four surfaces of the catadioptric condenser lens of FIG. 2.

FIG. 3b defines the radius and vertex for each of the four surfaces for the catadioptric condenser lens of FIG. 2.

FIG. 4 illustrates how the catadioptric condenser lens of FIG. 2 is used in a light collection system.

FIG. 5 is a drawing of the single-element, wide-field, catadioptric condenser lens of the second embodiment of this invention.

FIG. 6a is a sketch identifying the four surfaces of the catadioptric condenser lens of FIG. 5.

FIG. 6b defines the radius and vertex for each of the four surfaces for the catadioptric condenser lens of FIG. 5.

FIG. 7 illustrates how the catadioptric condenser lens of FIG. 5 is used in a light collection system.

FIG. 8a is a system level diagram of a single micromirror projector that uses the single element, catadioptric condenser lens of this invention.

FIG. 8b is a system level diagram of a three-micromirror, high brightness projector that uses the single element, catadioptric condenser lens of this invention.

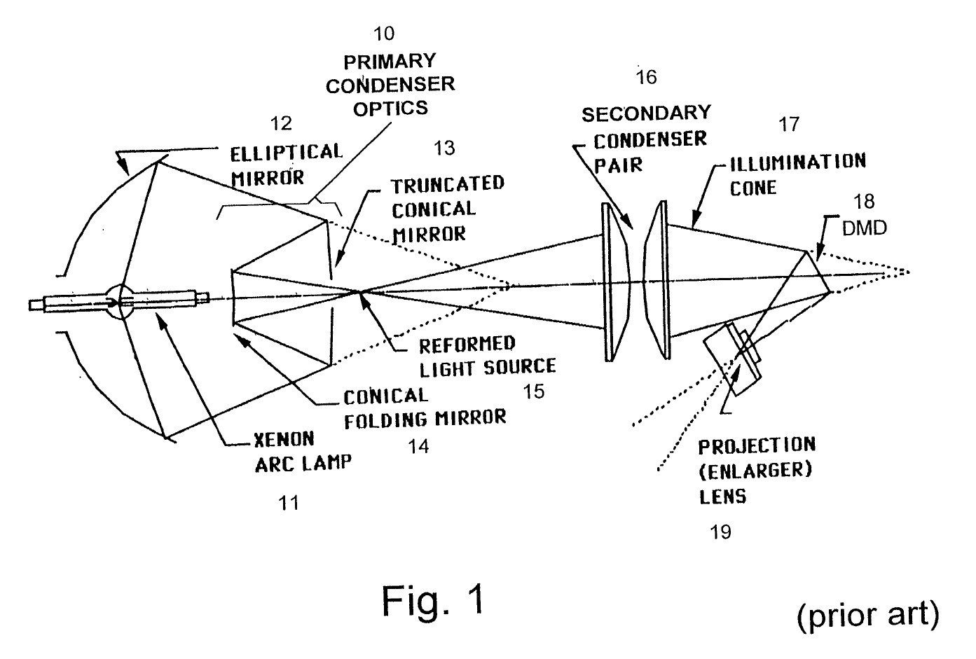

### DETAILED DESCRIPTION

This invention discloses two embodiments for a four-surface, single element, catadioptric condenser lens. Both embodiments are comprised of a low f-number (high numerical aperture) condenser lens with four optical surfaces. In both cases, two of these optical surfaces are reflective and are immersed in the lens refractive material. The details of the two embodiments are given below.

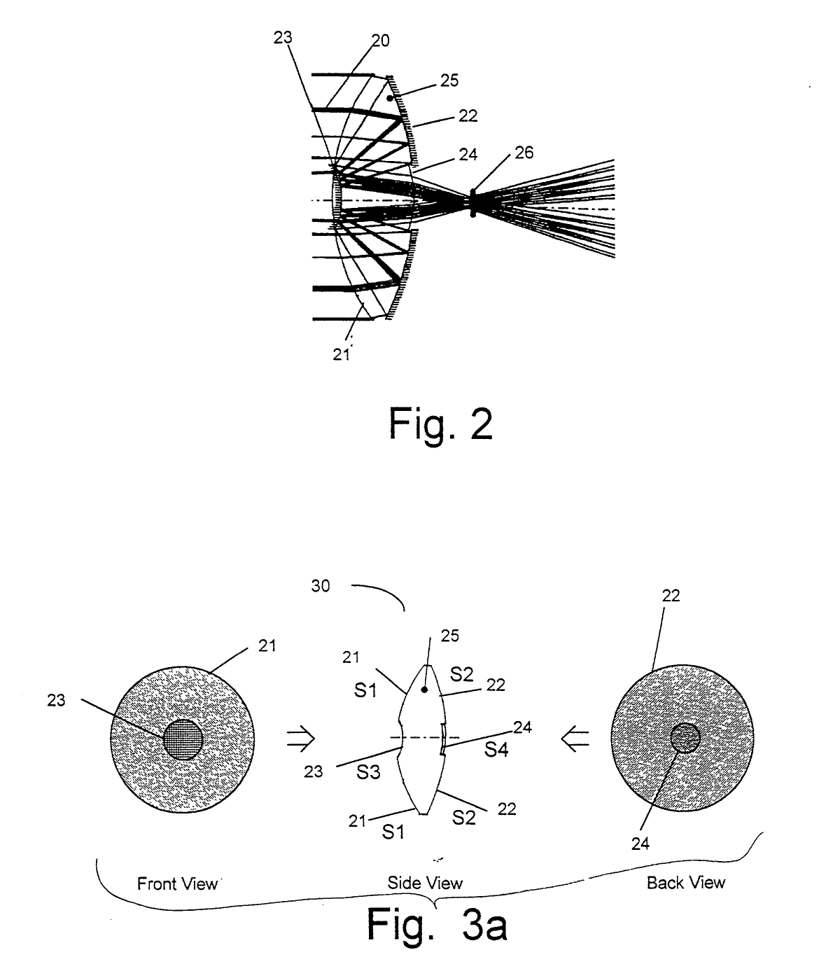

FIG. 2 is a drawing of the single element catadioptric condenser lens of embodiment one of this invention. In addition to the advantages of the condenser lens of this invention listed in the summary, this embodiment further improves the low obscuration properties of the lens. The condenser lens consists of two immersed zone reflector surfaces and two external zone reflector surfaces, as follows: (i) a surface zone, convex refractive surface 21, (ii) an immersed zone, concave primary reflector surface 22, (iii) an immersed zone, convex secondary reflector 23, and (iv) a surface zone, convex or concave refractive relay lens 24. Both the concave primary reflector 22 and convex secondary reflector 23 are immersed in the lens' refractive material 25. In operation, the incoming light rays 20 first strike the convex refractive surface 21 where the light is refracted (bent). The light beam is then doubled folded by reflecting first off the concave primary reflector surface 22 and then off the convex secondary reflector surface 23. Then the light is again refracted at the relay surface 24 and focused as a reformed image 26 of the source arc. With the reflective surfaces 22, 23 being fabricated into the same optical element as the refractive lens surfaces 21, 24, the positive power of the large convex refractive surface 21 bends the rays in such a way as to reduce the ray height at the convex secondary reflector 23, thereby allowing more light to be transmitted from the center portion of the collimator.

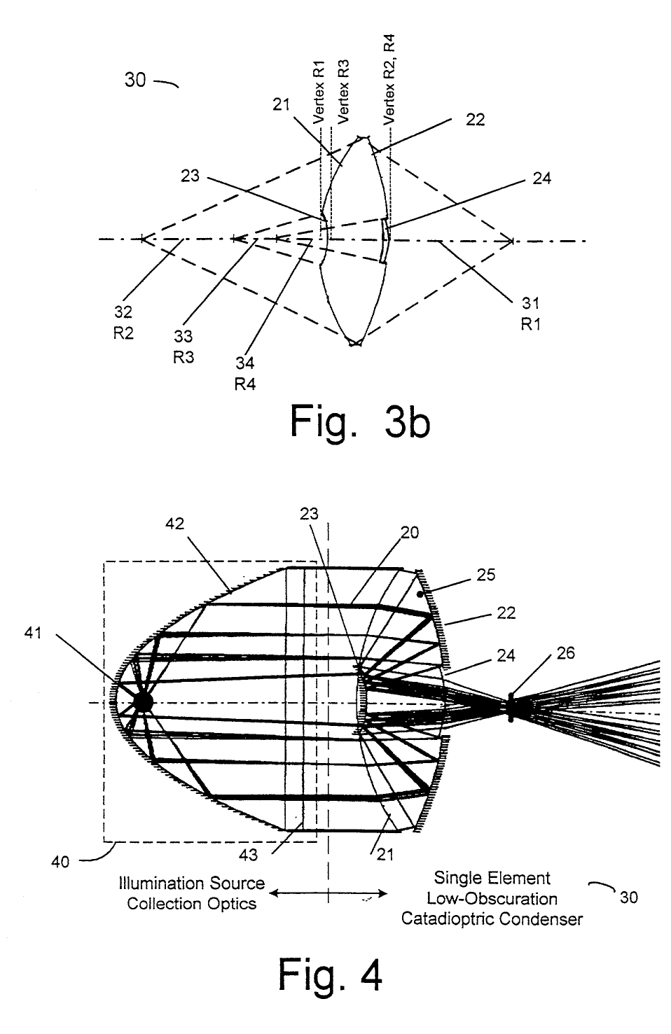

FIG. 3a includes three views (front, back, and side) of the single-element catadioptric condenser lens 30 that identifies the four optical surfaces; e.g., convex refractive surface (S1) 21, primary concave reflective surface (S2) 22, convex secondary reflective surface (S3) 23, and refractive relay surface (S4) 24. Again, both the concave primary reflector 22 and the convex secondary reflector 23 are immersed in the refractive material 25, while both the convex refractive surface 21 and the refractive relay 24 are zones located on the surface of the refractive material 25. Also, both the convex refractive surface 21 and the concave primary reflector 22 have holes in their center portion, as indicated, where the convex secondary reflector 23 and the refractive relay surface 24 are located, respectively.

FIG. 3b shows the center of radius and vertex locations for each of the surfaces in the catadioptric condenser lens 30 in the first embodiment of this invention. As an example, modeling data showing the radius dimensions, vertex locations, and conic constant for the four surfaces of the first embodiment of the condenser lens 30 are summarized in Table 1 below. The conic constant is a design parameter and is included for illustration purposes only in this example.

TABLE 1

| | | | | Conic |
|---|---|---|---|---|
| ID | Description | Vertex | Radius | Constant |
| S1 | Convex refractive | V = −0.98425 | R1 = +2.5000 | NA |
| | surface | | | |
| S2 | Concave primary | V = 0 | R2 = −3.2407 | k = −1.00 |
| | reflector surface | | | |
| S3 | Convex secondary | V = −0.86614 | R3 = −1.2857 | k = 8.5388 |
| | reflector surface | | | |
| S4 | Refractive relay | V = 0 | R4 = −1.2756 | k = 0 |
| | surface | | | |

Dimensions in inches

Note that the vertices for surfaces S2 and S4 are the same and are located at the reference point (0 inches) in this example. The radii for surfaces S2, S3, and S4 are negative, relative to the reference point (0 inches), while the radius for S1 is positive, as shown. The condenser lens 30 Is optimized for operation over the visible spectrum from 450-650 nanometers.

FIG. 4 is a block diagram illustrating how the catadioptric condenser lens 30 of the first embodiment of this invention is used in a light collection system. The single-element, low-obscuration catadioptric condenser lens 30, described above, is shown on the right side of the diagram. This condenser lens 30 is optically coupled to illumination source collection optics 40, shown on the left side of the diagram. The conventional collection optics 40 consist of a light source (lamp) 41, a parabolic reflector 42, and a light source window 43 (optional). The collection optics 40 are shown in conjunction with the catadioptric condenser lens 30 in this figure for illustrative purposes only. In operation, the parabolic reflector 42 reflects light 20 from the lamp 41. The function of the single-element, low-obscuration catadioptric condenser lens 30 is to capture as much of the incoming light 20 as possible and efficiently produce a reformed light source image 26. The condenser lens 30 is capable of collecting light at both large input angles and large pupil diameters. The positive power of the large aperture refractive surface of the condenser lens 30 bends the light rays in such a way as to reduce the ray height at the convex secondary reflector 23, thereby reducing the central obscuration caused by the lamp's leads, allowing more light to be transmitted and at the same time providing a uniform reformed light source image 26. The immersed configuration of the single-element condenser lens 30 also significantly improves the stray light rejection properties of the lens.

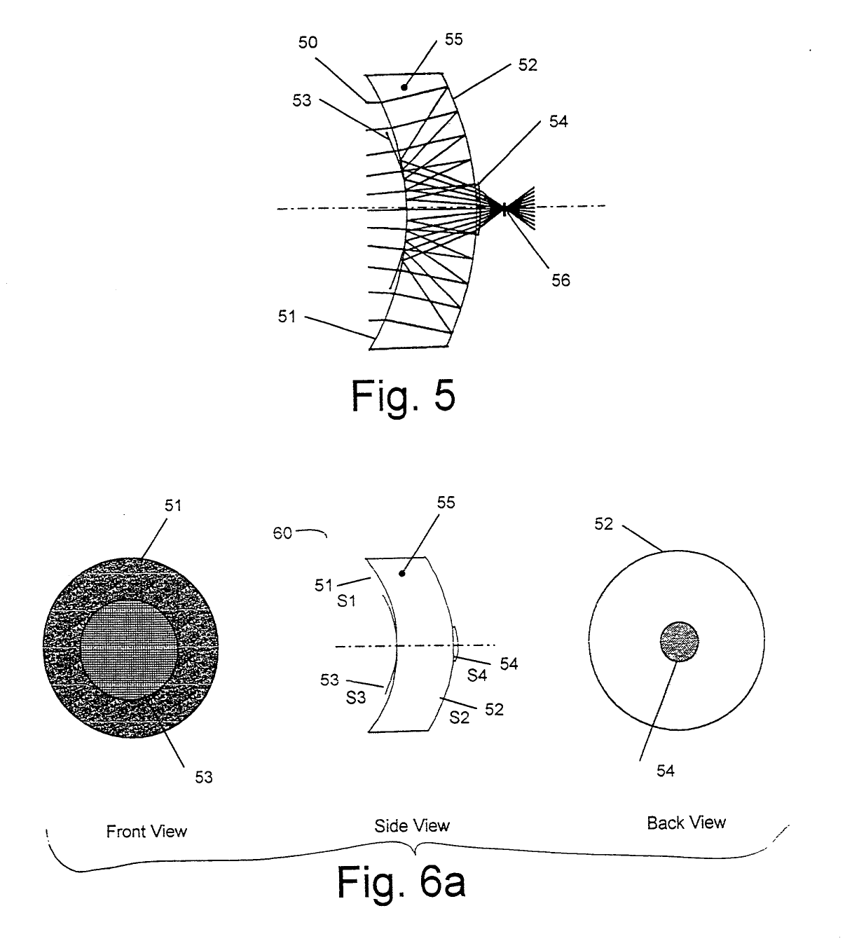

FIG. 5 is a drawing of the single-element catadioptric condenser lens of the second embodiment of this invention. In addition to the advantages of the condenser lens listed in the summary, this embodiment further improves the wide-angle properties of the lens. The condenser lens consists of two immersed zone reflector surfaces and two external zone reflector surfaces, as follows: (i) a surface zone, concave refractive surface 51, (ii) an immersed zone, concave primary reflector surface 52, (iii) an immersed zone, convex secondary reflector 53, and (iv) a surface zone, convex or concave refractive relay lens 54. Both the concave primary reflector 52 and the convex secondary reflector 53 are immersed in the lens' refractive material 55. In operation, the incoming light rays 50 first strike the concave refractive surface 51, where the light is refracted. The light beam is then double folded by reflecting first off the concave primary reflector surface 52 and then off the convex secondary reflector surface 53. Then the light is again refracted at the relay surface 54 and focused as a reformed image 56 of the source arc. With the reflective surfaces 52, 53 being fabricated into the same optical element as the refractive surfaces 51, 54, the negative power of the large concave refractive surface 51 bends the rays in such a way as to reduce the ray incidence angles at the concave primary reflector 52, thereby allowing more light to be transmitted. The convex secondary reflector 53 is made larger to improve the wide-field properties of the condenser lens.

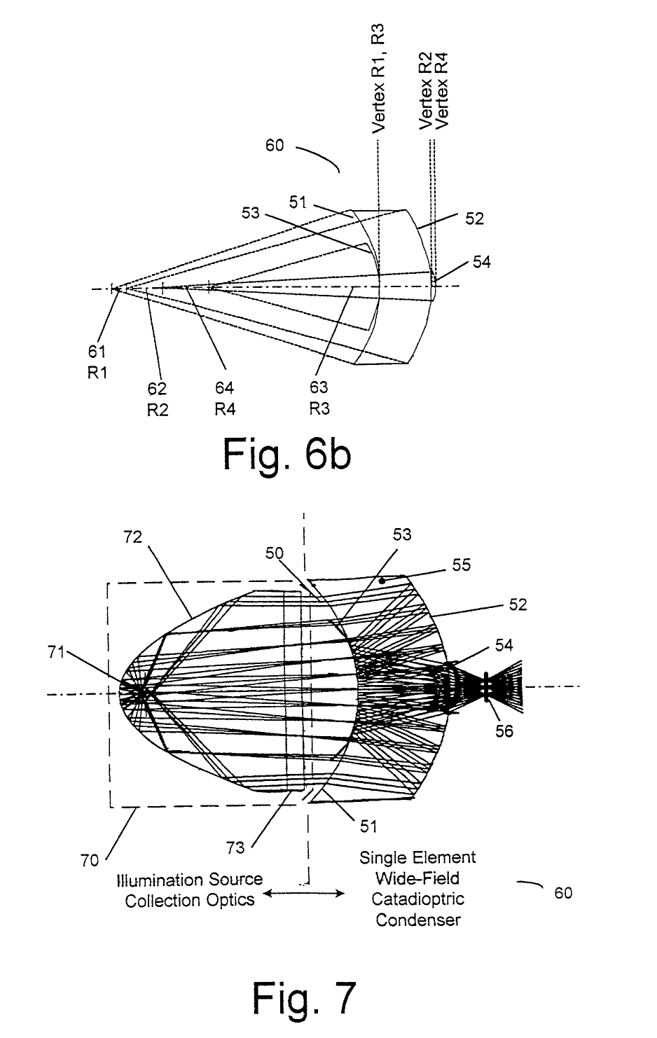

FIG. 6a is a sketch (front, back, and side views) of the single-element catadioptric condenser lens 60 that identifies the four optical surfaces; e.g., concave refractive surface (S1) 51, concave primary reflective surface (S2) 52, convex secondary reflective surface (S3) 53, and refractive relay surface (S4) 54. Again, both the concave primary reflector 52 and the convex secondary reflector 53 are immersed in the refractive material 55, while both the concave refractive surface 51 and the refractive relay 54 are zones located on the refractive material 55. Also, both the concave refractive surface 51 and the concave primary reflector 52 have holes in their center portion, as indicated, where the convex secondary reflector 53 and the refractive relay surface 54 are located, respectively.

FIG. 6b shows the radius and vertex locations for each of the surfaces in the catadioptric condenser lens 60 in the second embodiment of this invention. As an example, modeling data showing the radius dimensions and vertex locations for the four surfaces of the second embodiment of the condenser lens 60 are summarized in Table 2 below.

TABLE 2

| ID | Description | Vertex | Radius |
|---|---|---|---|
| S1 | Concave refractive | V = −0.765 | R1 = −2.899 |
| | surface | | |
| S2 | Concave primary | V = 0 | R2 = −3.277 |
| | reflector surface | | |
| S3 | Convex secondary | V = −0.765 | R3 = −1.825 |
| | reflector surface | | |
| S4 | Refractive relay | V = +0.039 | R4 = −3.277 |
| | surface | | |

Dimensions in inches

In this case, the vertex locations for the concave refractive surface S1 and the convex secondary reflector surface S3 are the same. As in the case for first embodiment of this invention, the condenser lens 60 is optimized for operation over the visible spectrum from 450-650 nanometers.

FIG. 7 is a block diagram illustrating how the catadioptric condenser lens 60 of the second embodiment of this invention is used in a light collection system. The single-element, wide-field catadioptric condenser lens 60, described above, is shown on the right side of the diagram. This condenser lens is optically coupled to illumination source optics 70, shown on the left side of the diagram. This conventional collection optics 70 consists of a light source (lamp) 71, a parabolic reflector 72, and a light source window 73 (optional). The collection optics 70 is shown in conjunction with the catadioptric condenser lens 60 in this figure for illustrative purposes only. In operation, the parabolic reflector 72 reflects light 50 from the lamp 71. The function of the single-element, wide-field catadioptric condenser lens 60 is to capture as much as possible of the incoming light 50 and efficiently produce a reformed light source image 56. The condenser lens 60 is capable of collecting light at large input angles and large pupil diameters. The negative power of the large concave refractive surface 51 of the condenser lens 60 bends the light rays in such a way as to reduce the ray incidence angles at the at the concave primary reflector 52, thereby allowing more light with less optical aberrations to be transmitted. The immersed configuration of the single-element condenser lens 60 also significantly improves the stray light rejection properties of the lens.

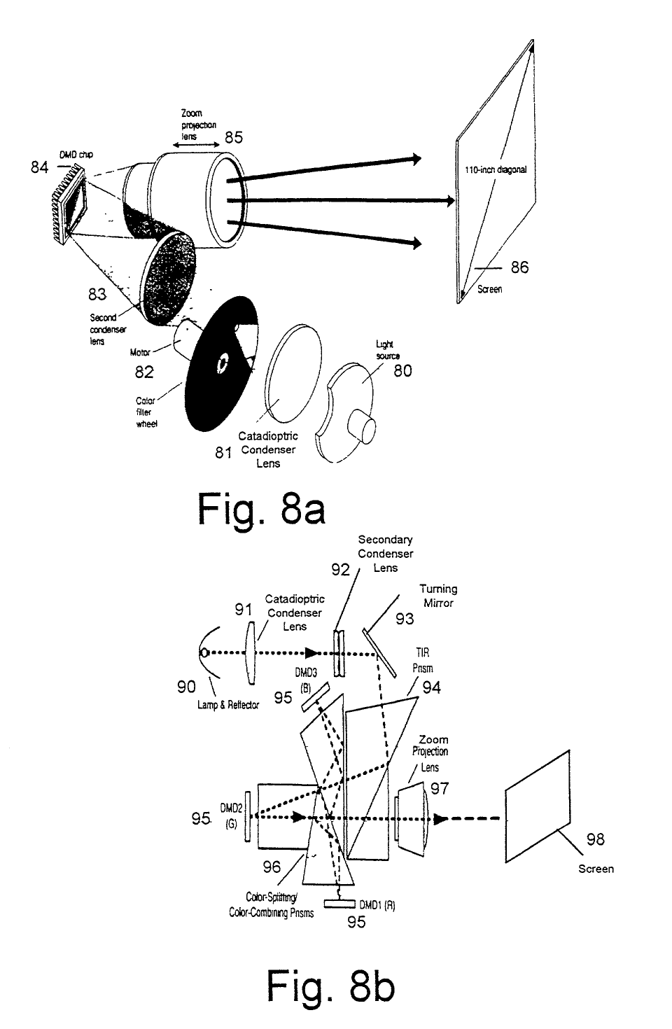

FIG. 8 shows a single and a three-chip spatial light module (SLM) projection display system, respectively, using one or the other catadioptric condenser lens of this invention. As a first example, FIG. 8a is a block diagram for a single micromirror device projection display, which consists of light source 80 (lamp and collector), the catadioptric condenser lens 81 of this invention, a color filter wheel and motor assembly 82, a secondary condenser lens 83, a micromirror chip 84, a zoom projection lens 85, and a projection screen 86. In operation, the catadioptric condenser lens 81 collects and reforms the light from the light source 80. The color filter wheel 82, which has red, green, and blue filter segments, filters the reformed light source and sequentially applies first red, then green, and then blue light (color sequence, example only) to the micromirror. The secondary condenser lens 83 consists of illumination optics used to reform/reconstruct as much as possible of the available light produced at the output of the catadioptric lens 81 onto the micromirror 84 surface. Light reflected from the micromirror pixels is then projected by means of a zoom lens 85 onto a viewing screen 86. The catadioptric condenser lens 81 of this invention improves the light collection efficiency and therefore the brightness of the projection system and significantly reduces optical aberrations in the overall projection system.

As another example, FIG. 8b is a block diagram for a three-micromirror projection display, which consists of a light source 90 (lamp and collector), the catadioptric condenser lens 91 of this invention, a secondary condenser lens 92, a turning mirror 93, a total-internal-reflective (TIR) prism 94, three micromirrors 95 (one each for red, green, and blue light frequencies), color splitting and combining prisms 96, a zoom projection lens 97, and a projection screen 98. Here three micromirrors 95, one dedicated to each of the there primary colors (red, green, and blue) are used. The total-internal-reflective (TIR) prism 94 and color-splitting and color combining prisms 96 are added to direct the appropriate red, green, and blue light to the appropriate micromirror. In this case, the secondary condenser lens 92 consists of illumination optics used to reform/reconstruct as much as possible of the available light at the output of the catadioptric condenser lens 91 into the TIR prism 94 and ultimately onto the micromirror surfaces 95. Light reflected from the three micromirror pixels is recombined by the combining prisms 96 and then projected by means of a zoom lens 97 onto a viewing screen 98. The three-micromirror projector is used in higher brightness applications, such as for cinema and/or large conference centers. As in the case of the single micromirror projector, the catadioptric condenser lens 91 of this invention improves the light collection efficiency and therefore-the brightness of the projection system. In addition, there is a significant reduction in the optical aberrations in the overall brightness of the 3-micromirror projection system.

While this invention has been described in the context of two preferred embodiments, it will be apparent to those skilled in the art that the present invention may be modified in numerous ways and may assume embodiments other than that specifically set out and described above. Accordingly, it is intended by the appended claims to cover all modifications of the invention that fall within the true spirit and scope of the invention.

What is claimed is:

1. A catadioptric condenser lens with low obscuration properties comprising:
a refractive base material so shaped as to have a first surface and an opposing second surface;
said first surface being a convex refractive zone on the surface of said base material;
said second surface being a concave primary reflector surface immersed in said base material;
a third surface being a convex secondary reflector surface immersed in said base material and positioned in the center of said first convex refractive surface; and
a fourth surface being a convex or concave refractive relay lens on the surface of said base material and positioned at the center of said second concave primary reflector surface.

2. The catadioptric condenser lens of claim 1, constructed as a single lens element with reflective and/or refractive surfaces integrated into or on the surface of said base material.

3. The catadioptric condenser lens of claim 1, wherein the positive power of said first convex refractive surface bends the light rays in such a way as to reduce the ray height at said second concave primary reflector surface, thereby reducing central obscuration and allowing maximum light to be transmitted.

4. A catadioptric condenser lens with wide-field properties comprising:
a refractive base material so shaped to have a first surface and an opposing second surface;
said first surface being a concave refractive zone on the surface of said base material;
said second surface being a concave reflector surface immersed in said base material;
a third surface being a convex secondary reflector surface immersed in said base material and positioned in the center of said first concave refractive surface; and
a fourth surface being a convex or concave refractive relay lens on the surface of said base material and positioned at the center of said second concave primary reflector surface.

5. The catadioptric condenser lens of claim 4, which is constructed as a single lens element with reflective and/or refractive surfaces integrated into or on the surface of said refractive base material.

6. The catadioptric condenser lens of claim 4, wherein the negative power of said first concave refractive surface bends the light rays in such a way as to reduce the ray incidence angles at the said second primary reflector surface, allowing said second primary reflector surface to be spherical, thereby providing compensation for optical aberrations.

7. A light source comprising:
a lamp for emitting light;
a lamp reflector for directing said light along a light path; and
a catadioptric condenser lens on said light path for focusing said beam of light, said catadioptric condenser lens further comprising:
a first surface being a convex refractive zone on the surface of said base material;
a second surface being a concave primary reflector surface immersed in said base material;
a third surface being a convex secondary reflector surface located at the center of said first convex refractive surface and being immersed in said base material; and
a fourth surface being a convex or concave refractive relay lens on the surface of said base material and positioned at the center of said second concave primary reflector surface.

8. A light source comprising:
a lamp for emitting light;
a lamp reflector for directing said light along a light path; and
a catadioptric condenser lens on said light path for focusing said beam of light, said catadioptric condenser lens further comprising:
a first front surface being a concave primary refractive zone on the surface of said base material;
a second back surface being a concave reflector surface Immersed in said base material;
a third surface being a convex secondary reflector surface immersed in said base material and positioned in the center of said first concave refractive surface; and
a fourth surface being a convex or concave refractive relay lens on the surface of said base material and positioned at the center of said second concave primary reflector surface.
